(19) United States
(12) Patent Application Publication
(10) Pub. No.: US 2007/0050427 A1
(43) Pub. Date: Mar. 1, 2007

(54) SYSTEM AND METHOD FOR VALIDATING APPLICATION GLOBALIZATION ISSUES AND COMPUTER PRODUCT

(76) Inventors: STEVEN ATKIN, Wesley Chapel, FL (US); Xing Jiang Huang, Shanghai (CN); Jue Wang, Shanghai (CN); Luis Zapata, Wake Forest, NC (US)

Correspondence Address: IBM CORPORATION;INTELLECTUAL PROPERTY LAW, 11400 BURNET ROAD, AUSTIN, TX, 78758, US

(21) Appl. No.: 11/461,434

(22) Filed: Jul. 31, 2006

(30) Foreign Application Priority Data
Aug. 2, 2005 (CN) 200510089331.8

(51) Int. Cl. G06F 17/30

(52) U.S. Cl. 707/201

(57) ABSTRACT

A system, method, and computer product for validating application globalization issues are provided herein. In accordance with one embodiment of the present invention, a computer system is provided which comprises a globalization rules indicating component; an application static analyzing component; an application running component; an application dynamic analyzing component; and a validation matrix component. Using bidirectional interaction between static analysis and dynamic analysis, the weakness of static and dynamic analysis is remedied and the number of warnings that developers need to investigate is reduced.

### CROSS-REFERENCE TO RELATED APPLICATIONS

This application claims the benefit of priority of Chinese Patent Application No. 200510089331.8 filed on Aug. 2, 2005, and entitled “SYSTEM AND METHOD FOR VALIDATING APPLICATION GLOBALIZATION ISSUES AND COMPUTER PRODUCT” hereby incorporated by reference herein for all purposes.

### BACKGROUND

1. Technical Field

The present invention relates to an application validating system and method. Specifically the present invention relates to a computer system and method for validating application globalization issues with the help of a globalization rules validation matrix, and a computer product for storing a computer readable program for performing operations of the described method.

2. Description of Related Art

IBM software products need to meet corporate globalization requirements listed in Globalization Whitepaper and Globalization Architecture Imperative to serve global market. However, many globalization issues in IBM products are difficult to be found early in the development phase. The defects that escape early detection in Globalization Verification Test and Translation Verification Test not only cause serious rework, but also increase the development cost significantly. Therefore it is required that developers find globalization issues early in the development phase so as to facilitate post development.

There are mainly two conventional methods for Globalization Verification Test and Translation Verification Test as follows, a common purpose of which is to reduce the number of source code warnings that the developers have to investigate. The first kind of method is to use static analysis technology to search syntactic globalization issues in the source code of an application program. The second kind of method is to use dynamic analysis technology to search semantic runtime globalization issues. The existing technologies in this field can be found in web sites such as http://www-306.ibm.com/software/awdtools/developer/application/index.html.

Currently, there are several solutions for either static analysis or dynamic analysis. But almost all kinds of static analysis have the limitation that it is hard to understand the application runtime environment and identify the call sequence of object methods. The dynamic analysis also has the limitation that it is difficult to understand the overall logic of the application, and dynamic analysis relies on the executed paths to analyze the application and cannot cover the overall application logic. The validation matrix uses static analysis, dynamic analysis and a mixture of two methods to enable the interactions of these two methods to get more precise understanding of the issues, eliminate false warnings and get the maximum of validation scope.

Therefore, it is necessary to develop a better computer system and method for Globalization Verification Test and Translation Verification Test.

### BRIEF SUMMARY

A system, method, and computer product for validating application globalization issues are provided herein. In accordance with one embodiment of the present invention, a computer system for validating application globalization issues using globalization rules is provided which comprises a globalization rules indicating component or “part” to implement the globalization rules as XML definitions and probe definitions; an application static analyzing component to search for syntactic globalization issues in application source code using a static analysis technology and the XML definitions; an application running component to run an application whose globalization issues are to be validated and to generate a runtime environment of the application; an application dynamic analyzing component to dynamically analyze the runtime environment using a dynamic analysis technology and the probe definitions, so as to search for semantic globalization issues in the runtime environment; and a validation matrix component to control the globalization rules indicating component, the application static analyzing component, and the application dynamic analyzing component to validate the application globalization issues according to an execution sequence determined using the globalization rules.

The foregoing is a summary and thus contains, by necessity, simplifications, generalizations and omissions of detail; consequently, those skilled in the art will appreciate that the summary is illustrative only and is not intended to be in any way limiting. As will also be apparent to one of skill in the art, the operations disclosed herein may be implemented in a number of ways including implementation in hardware, software, or a combination thereof, and such changes and modifications may be made without departing from this invention and its broader aspects. Other aspects, inventive features, and advantages of the present invention, as defined solely by the claims, will become apparent in the non-limiting detailed description set forth below.

### BRIEF DESCRIPTION OF THE DRAWINGS

It is believed that the above features, advantages and purposes of the invention will be better understood from the following description of the preferred embodiments of the invention taken in conjunction with the accompany drawings, in which:

FIG. 1 is a schematic diagram of architecture of validating globalization issues of an application by using a validation matrix of globalization rules according to the present invention;

FIG. 2 is a schematic diagram of the detailed structure of the validation matrix part;

FIG. 3 shows an operation flow chart of a rules manager 210 according to the present invention;

FIG. 4 is a sample application screen capture view according to the present invention;

FIG. 5 is a view showing a static analysis result according to an embodiment of the present invention; and

FIG. 6 is a view showing a dynamic analysis result according to an embodiment of the present invention.

The use of the same or similar reference symbols within the accompanying drawings is intended to indicate similar or identical items.

### DETAILED DESCRIPTION

The general inventive concept of the present invention will be described hereinafter by describing an embodiment with reference to the drawings, in which like reference numerals refer to identical elements throughout.

Embodiments of the present invention include and utilize derived development best practices and a set of identified globalization rules with problem examples and solution suggestions. Based on these globalization rules, a globalization rules validation matrix is created. The matrix is usually used to help developers to find globalization issues early in the development phase. The matrix can also be used post development.

In one embodiment of the present invention, a computer system and method for validating application globalization issues by using the validation matrix of the globalization rules is provided. The system and method enables the mixture of static analysis and dynamic analysis through the validation matrix of the globalization rules so as to get a more precise understanding of the issues, eliminate false warnings and get the maximum of validation scope through the interactions of the two methods.

According to another embodiment of the present invention, there is provided a computer system for validating application globalization issues by using globalization rules, comprising a globalization rules indicating component to implement the globalization rules as XML definitions and probe definitions; an application static analyzing component to search for syntactic globalization issues in application source code using a static analysis technology and the XML definitions implemented by the globalization rules indicating component; an application running component to run an application whose globalization issues are to be validated and to generate a runtime environment of the application; an application dynamic analyzing component to dynamically analyze the application runtime environment using a dynamic analysis technology and the probe definitions of the globalization rules implemented by the globalization rules indicating component, so as to search for semantic globalization issues in the runtime environment; and a validation matrix component to control the globalization rules indicating component, the application static analyzing component, the application running component and the application dynamic analyzing component to validate the application globalization issues according to a execution sequence determined using the globalization rules.

In another embodiment of the present invention, there is provided a method for validating application globalization issues using globalization rules in a computer system, the method comprising: storing globalization issues for validation, and determining an execution sequence of static analysis engine and dynamic analysis engine through the definitions of the globalization rules, the definitions of the globalization rules being made up of by the execution sequence input by a globalization expert, class name, method name and line number, which are recorded; instructing a corresponding analysis engine to perform analysis of the globalization issues prescribed by the execution sequence according to the determined execution sequence and related information about a globalization rules set for analysis; according to the class name, method name, line number, content and status as the analysis result, directly finding some potential rule violations with this rule in the case of static analysis, and in the case of dynamic analysis, first running the application whose globalization issues are to be validated, then using a testcase corresponding to a special class to find some potential rule violations with this rule; based on the analysis result and a determination result of whether another rule set of the globalization rules implementation should be used for dynamic analysis/static analysis, in the case that the other rule set of the globalization rules implementation is used for dynamic analysis/static analysis, receiving a globalization rule set for dynamic analysis/static analysis, and further receiving a testcase if it is dynamic analysis case, so as to use the received globalization rule set for dynamic analysis/static analysis and/or the testcase to call a corresponding dynamic analysis/static analysis engine; and generating a report and presenting it to an end user according to the class name, method name, line number, content and status as the execution result of the analysis engine.

In yet another embodiment of the present invention, there is provided a computer product for storing computer program codes thereon in a computer readable format to enable a computer system to execute the computer program codes so as to implement a method comprising: storing globalization issues for validation, and determining an execution sequence of static analysis engine and dynamic analysis engine through the definitions of the globalization rules, the definitions of the globalization rules being made up of by the execution sequence input by a globalization expert, class name, method name and line number, which are recorded; instructing corresponding analysis engine to perform the analysis of the globalization issues prescribed by the execution sequence according to the determined execution sequence and related information about a globalization rules set for analysis; according to the class name, method name, line number, content and status as the analysis result, directly finding some potential rule violations with this rule in the case of static analysis, and in the case of dynamic analysis, first running the application whose globalization issues are to be validated, then using a testcase corresponding to a special class to find some potential rule violations with this rule; based on the analysis result and a determination result of whether another rule set of the globalization rules implementation should be used for dynamic analysis/static analysis, in the case that the other rule set of the globalization rules implementation is used for dynamic analysis/static analysis, receiving a globalization rule set for dynamic analysis/static analysis, and further receiving a testcase if it is dynamic analysis case, so as to use the received globalization rule set for dynamic analysis/static analysis and/or the testcase to call a corresponding dynamic analysis/static analysis engine; and generating a report and presenting it to an end user according to the class name, method name, line number, content and status as the execution result of the analysis engine.

The above embodiments of the present invention merge the output of static analysis and the output of dynamic analysis to resolve the issues existing in both semantic and syntactic areas. Its major advantage is the bi-directional interaction between static analysis and dynamic analysis which remedies weaknesses of static and dynamic analysis and reduces the number of warnings that developers need to investigate.

In addition, according to one or more embodiments of the present invention, the function call and communication between static analysis and dynamic analysis are automatic. The validation matrix will pick up the analysis method automatically according to globalization rule definition and scanning situation.

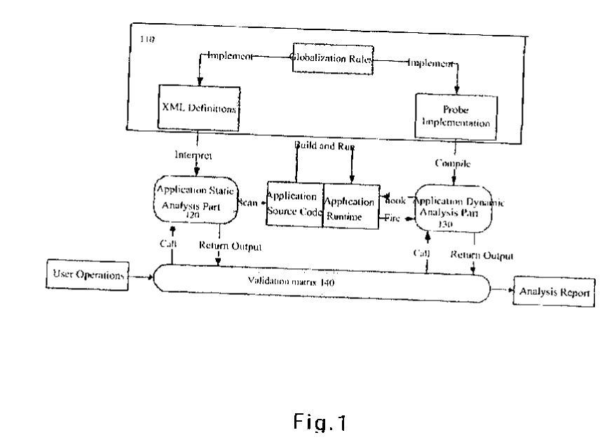

FIG. 1 is a schematic diagram of architecture of validating globalization issues of an application by using a validation matrix of globalization rules according to the present invention. Referring to FIG. 1, the architecture of validating globalization issues of an application comprises a globalization rule indicating part 110, an application static analyzing part 120, an application dynamic analyzing part 130 and a validation matrix part 140.

The globalization rule indicating part 110 can implement the globalization rules as XML definitions and probe definitions. The XML definitions and probe definitions will be used by the application static analyzing part 120 and the application dynamic analyzing part 130, respectively, for analyzing the globalization issues of the application.

The application static analysis part 120 uses static analysis technology to search for syntactic globalization issues in the application source code. According to an embodiment of the present invention, Rational Application Analyzer developed by IBM Corporation can be used as the static analysis engine of the application static analysis part 120. The Rational Application Analyzer can be found in the following web site: http://www-306.ibm.com/software/awdtools /developer/application/index.html. In this case, the application static analysis part 120 will use the Rational Application Analyzer with the help of the implementation of XML definitions of the Globalization rules to scan the source code to detect the globalization issues. However, since this kind of analysis engine cannot understand the whole runtime environment instead of piece of code, using the application static analysis part 120 alone to conduct application source code analysis may cause some false warnings.

Therefore, it is necessary to use the application dynamic analysis part 130 to conduct dynamic analysis for the application runtime environment so as to search for semantic runtime globalization issues. In an embodiment of the present invention, Rational ProbeKit developed by IBM Corporation can be used as the dynamic analysis engine of the application dynamic analysis part 130. The Rational ProbeKit can be found in the following web site: http://www-306.ibm.com/software/awdtools/developer/application/index.html. In order to use the application dynamic analysis part 130 to analyze the application globalization issues, globalization rules need to be implemented as probes. The application dynamic analysis part 130 uses the Rational ProbeKit to detect globalization defects in the application runtime environment. When initializing the application dynamic analysis part 130, the computer system of the present invention will run the application to conduct globalization issue verification so as to generate the application runtime environment. The task of generating the application runtime environment can be implemented by an application running part (not shown) of the computer system of the present invention.

In the process of running the application dynamic analysis part 130, once a special class or method that the probe hooked is called by an application, the probe will be fired and the program in the probe will be executed so as to search for globalization issues that may exist in the special class or method. However, since it is very hard to go through all execution paths for a complex application, some issues will be missed if the execution paths on these issues are not covered.

Both Rational Application Analyzer and Rational ProbeKit are included as plug-in in Rational Application Developer. Rational Application Developer can be found in the following web site: http://www-306.ibm.com/software/awdtools/developer/application/index.html.

As mentioned above, since both using the application static analyzing part 120 and the application dynamic analyzing part 130 individually to analyze the globalization issues of the application have defects, in an embodiment of the present invention, the application static analyzing part 120 and the application dynamic analyzing part 130 are intended to be merged to conduct the analysis of the globalization issues of the application. This kind of merge is implemented by using the validation matrix part 140.

The validation matrix part 140 can utilize the output from Rational Application Developer to instruct Rational ProbeKit to run a special probe in the runtime environment to detect if the value used in the specific class or method has a real globalization issue. The output of Rational ProbeKit will return to Rational Application Analyzer via validation matrix to eliminate the false warnings. The bi-directional interaction will remedy the weakness of static and dynamic analysis and reduce the number of warnings that developers need to investigate.

The validation matrix part 140 can be used as plug-in in Rational Application Developer for controlling other parts of the architecture of application globalization issues, including a globalization rule indicating part 110, an application static analyzing part 120 and an application dynamic analyzing part 130, so as to decide which execution sequence will be used for which situation. The validation matrix part 140 will also analyze the rules coverage and generate the analysis report.

The validation matrix part 140 can integrate static analysis and dynamic analysis into one matrix and enable bi-directional communication between static analysis and dynamic analysis to identify real globalization defects and eliminate false warnings. The validation matrix part 140 can also determine which analysis method will be used based on the applicable globalization rule, and provide a uniform user interface for reception of user input, defects detection, fixing and reporting.

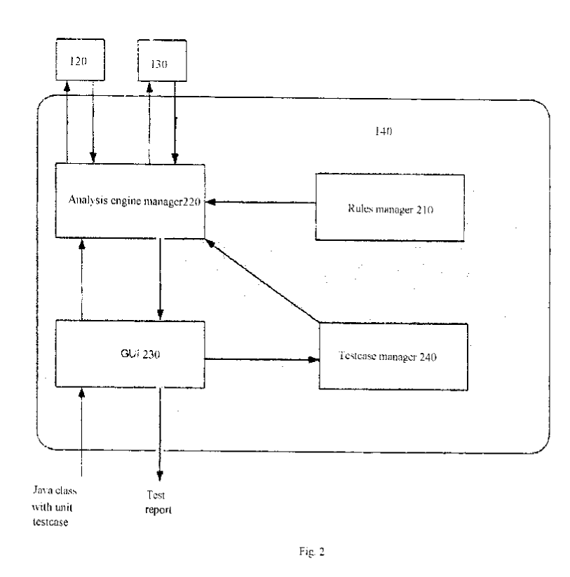

FIG. 2 is a schematic diagram of the detailed structure of the validation matrix part 140. Referring to FIG. 2, an implementation of the validation matrix part 140 comprises such four components as a rules manager 210, an analysis engine manager 220, a GUI 230 and a testcase manager 240.

Herein, the analysis engine manager 220 controls the execution of the static analysis engine of the application static analyzing part 120 and the dynamic analysis engine of the application dynamic analyzing part 130. The analysis engine manager 220 starts or stops the execution of analysis engines, provides inputs to the analysis engines and receives outputs from the analysis engines. The analysis engine manager 220 collects interaction information from two analysis engines, transforms the output from the application static analyzing part 120 as the input to the application dynamic analyzing part 130, and vice versa. The basic interaction information is class name, method name, line number and rule ID.

The rules manager 210 stores the globalization rules knowledge that will be used for the validation. The execution sequence of the static analysis engine and dynamic analysis engine is determined by the globalization rule's definition. When a globalization expert inputs the globalization rules to the rules manager 210, the execution sequence (static first, static only, dynamic first and dynamic only) and required parameters (class, method and line number) will be recorded, wherein the static first indicates the application static analyzing part 120 first performs static analysis on an application, then the application dynamic analyzing part 130 performs dynamic analysis; the static only indicates that only the application static analyzing part 120 performs static analysis on an application; the dynamic first indicates the application dynamic analyzing part 130 first performs dynamic analysis on an application, and then the application static analyzing part 120 performs static analysis; and the dynamic only indicates only the application dynamic analyzing part 130 performs dynamic analysis on an application. Before the execution of application analysis, the analysis engine manager 220 will inquire the rules manager 210 about the globalization rule set that will be used for the analysis. Based on the execution result of the analysis, the analysis engine manager 220 will also inquire the rules manager 210 whether another set of rules implementation should be used for dynamic/static analysis.

Next the testcase manager 240 in the validation matrix part 140 will be described. According to an embodiment of the present invention, the testcase manager 240 is used to store all unit testcases for the application used for dynamic analysis. The testcase manager 240 will record the mapping between application classes/methods and unit testcases. When the analysis engine manager 220 wants to analyze a specific class or method, the testcase manager 240 will find the right unit testcase for the class or method and give the unit testcase to the analysis engine manager 220. Then the analysis engine manager 220 can execute the unit testcase to start dynamic analysis.

The GUI 230 is the user interface of the validation matrix part 140. The GUI 230 will accept the user input and generate report for end users.

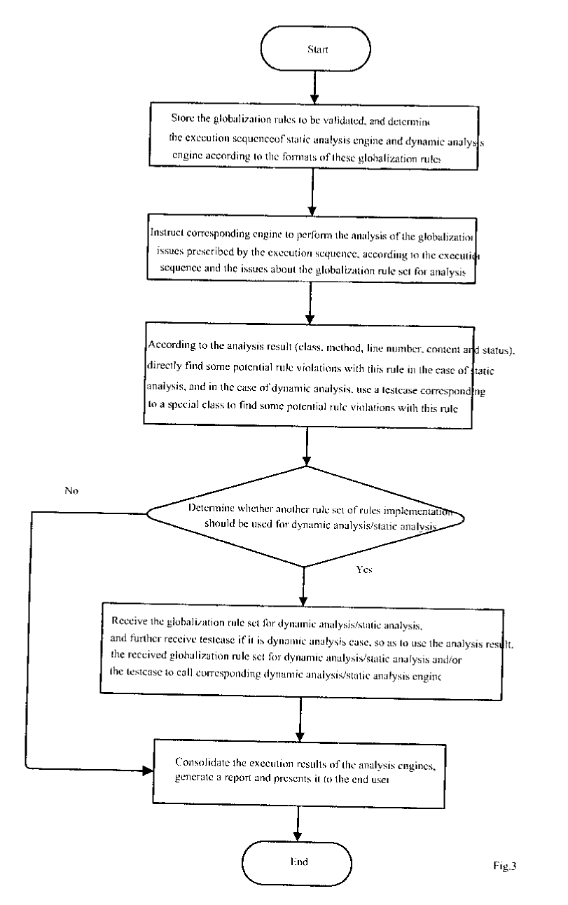

FIG. 3 shows an operation flow chart of the validation matrix part 140 according to the present invention. At step S310, the rules manager 210 in the validation matrix part 140 stores the globalization rules knowledge that will be used for the validation, and the execution sequence of the static analysis engine and dynamic analysis engine is determined by the globalization rule's definition. Specifically, when a globalization expert inputs the globalization rules to the rules manager 210, the execution sequence (static first, static only, dynamic first and dynamic only) and required parameters (class, method and line number) will be recorded.

Then, at step S320, before the execution of application analysis according to the execution sequence, the analysis engine manager 220 will inquire the rules manager 210 the issue about the globalization rule set that will be used for the analysis, and instruct corresponding engine to perform analysis of the globalization issues prescribed by the execution sequence.

At step S330, according to the analysis result (class, method, line number, content and status), the analysis engine manager 220 directly finds some potential rule violations with this rule in the case of static analysis, and in the case of dynamic analysis, uses a testcase corresponding to a special class in the testcase manager 240 (described later) to find some potential rule violations with this rule.

Next, at step S340, based on the analysis execution result, the analysis engine manager 220 inquires the rules manager 210 to determine whether another rule set of rules implementation should be used for dynamic analysis/static analysis. If the inquiry result of the analysis engine manager 220 is that the other rule set of rules implementation should be used for dynamic analysis/static analysis, then the operation proceeds to step S350, where the analysis engine manager 220 receives the globalization rule set for dynamic analysis/static analysis from the rules manager 210, and further receives testcase if it is dynamic analysis case, so as to use the received globalization rule set for dynamic analysis/static analysis and/or the testcase to call corresponding dynamic analysis/static analysis engine. Then the operation proceeds to step S360, where the analysis execution result (class, method, line number, content and status) is returned to the analysis engine manager 220, where the analysis execution results are consolidated and a report is generated and presented to the end user via the GUI 230.

If the inquiry result of the analysis engine manager 220 is that the other rule set of rules implementation is not used for dynamic analysis/static analysis, then the operation proceeds to step S360, where the analysis engine manager 220 generates a report and presented it to the end user via the GUI 230 (described below).

As can be seen from the above detailed description for the preferred embodiment, the globalization rule validation matrix according to the present invention is not a simple merge of static analysis and dynamic analysis, but it is a value-add to existing solutions. The solution of the present invention overcomes the limitation of the static analysis that it is difficult to understand the application runtime environment, and also overcomes the limitation of the dynamic analysis that it is difficult to understand the overall logic of the application. The present invention uses a mixture of static analysis and dynamic analysis through the globalization rules validation matrix so as to get a more precise understanding of the issues, eliminate false warnings and get the maximum of validation scope through the interactions of the two methods.

In addition, according to a preferred embodiment of the present invention, the function call and communication between static analysis and dynamic analysis are automatic. The validation matrix will pick up the analysis method automatically according to globalization rule definition and scanning situation.

The operation of the validation matrix part 140 will be exemplified below.

Sample 1:

The rule is “Avoid using java.lang.String.toUpperCase (java.util.Locale) for strings containing supplementary characters”. The execution sequence for this rule will be:_
1. The rules manager 210 records the rule's execution sequence as “static first”, which means the static analysis will be executed at first, and then the dynamic analysis will be executed.
2. Once the static analysis result (class, method, line number, content and status) is derived, the analysis engine manager 220 finds some potential rule violations with this rule.
3. The analysis engine manager 220 inquires the rules manager 210 if the dynamic analysis is required for these violations.
4. The rules manager 210 responds testcase and dynamic rule implementation to the analysis engine manager 220.
5. The analysis engine manager 220 calls the dynamic analysis using testcase with the specific rule implementation.
6. The dynamic analysis returns the execution result (class, method, line number, content and status) to the analysis engine manager 220.
7. The analysis engine manager 220 consolidates the execution results of both static and dynamic analysis, generates a report and presents it to the end user via the GUI 230.

Sample 2:

The rule is “Avoid using String.charAt( ) for multilingual string”. Both static analysis (using Rational Application Analyzer) and dynamic analysis (using ProbeKit) implement this rule.

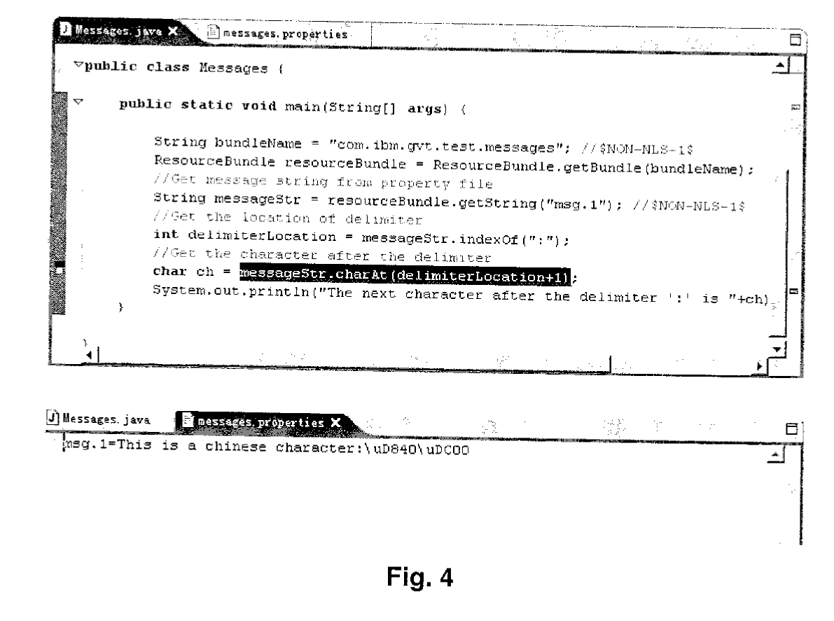

FIG. 4 is a sample application screen capture view. Referring to FIG. 4, in this case, the application wants to read a message from “message.properties” and prints a character after the delimiter “:” in the system console. The key code in the application is:
char ch=messageStr.charAt(delimeterLocation+1);

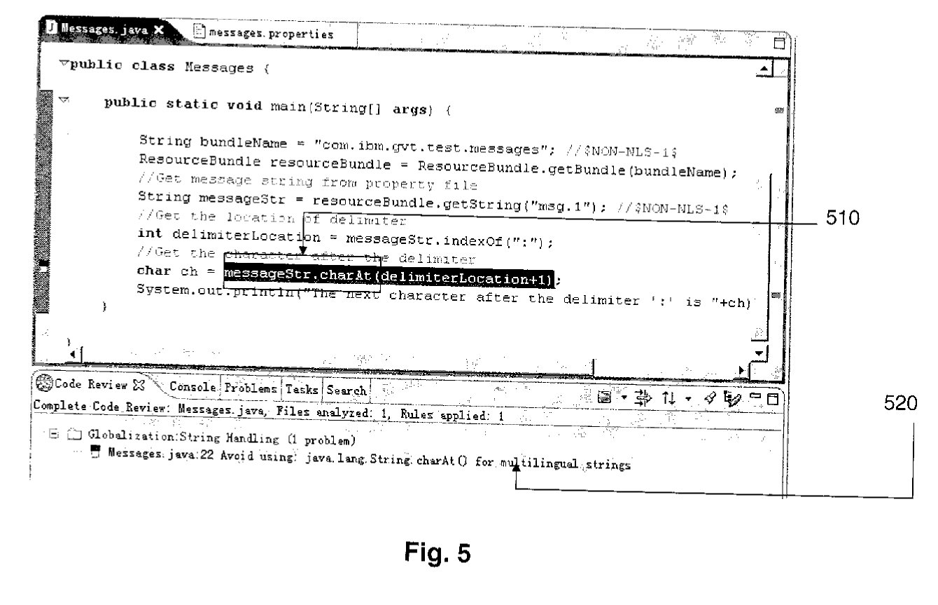

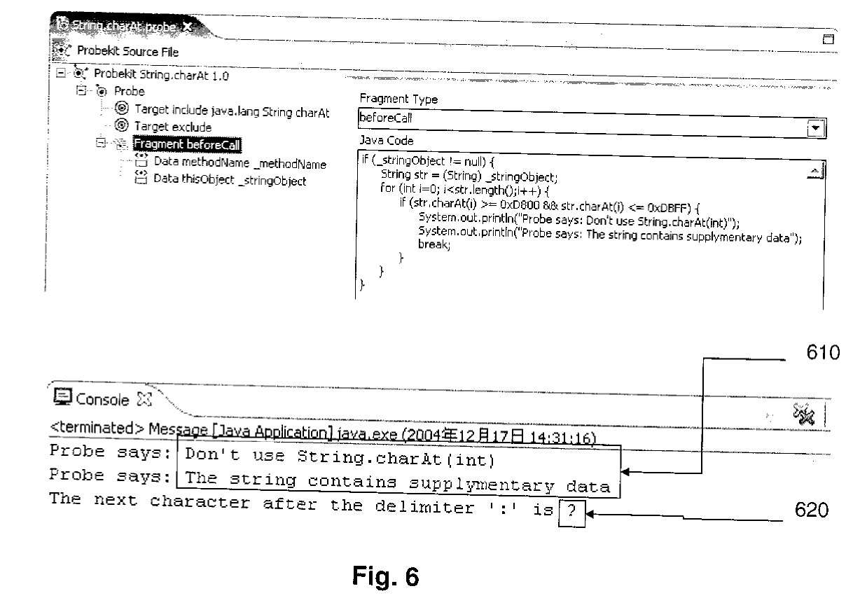

Here are the execution steps of the validation matrix part 140:_
1. The end user starts the validation through the GUI 230. The GUI 230 reports that the unit testcases for this application are required for dynamic analysis;
2. The end user inputs the unit testcases, and the GUI 230 puts the linkage between testcase and class into the testcase manager 240 according to the user input;
3. The GUI 230 sends the validation request to the analysis engine manager 220.
4. The analysis engine manager 220 calls the static analysis engine to perform static analysis.
5. The static analysis engine completes the analysis and returns the result to the analysis engine manager 220, and the static analysis indicates there may be a rule violation “messageStr.charAt”. FIG. 5 shows the static analysis result of the sample. Referring to FIG. 5, reference numeral 510 indicates the rule violation “messageStr.charAt”. Since the context of “messageStr” is not known, whether it is a real globalization issue cannot be determined only by static analysis. Reference numeral 520 indicates the analysis result, which indicates a globalization issue may exist in the static analysis.
6. However, because static analysis cannot know whether messageStr contains multilingual data or not, so the analysis engine manager 220 inquires the rules manager 210 about the next action. The rules manager 210 responds to the analysis engine manager 220 that dynamic analysis should be executed. Then the analysis engine manager 220 determines to call dynamic analysis to see if there is multilingual data in messageStr.
7. The analysis engine manager 220 looks up the data in the testcase manager 240 and finds the corresponding unit testcase for dynamic analysis.
8. The analysis engine manager 220 calls dynamic analysis engine to hook the probe and run the testcase.
9. The globalization rule implementation of dynamic analysis is fired by dynamic analysis engine and tells the validation engine messageStr contains multilingual data in this case. FIG. 6 shows the dynamic analysis result of the sample. Referring to FIG. 6, reference numeral 610 indicates an issue detected by the probe. Reference numeral 620 indicates an interrogation mark which indicates that a real globalization issue happens in the runtime environment.
10. Then the validation engine can report to end user and say there is a real globalization rule violation in this application.

Sample 3:

Another sample is the rule “Avoid using string concatenation for translatable messages”. The sample code is:
Log4j.log(“The sql error code is: ”+getErrorCode( ));

Obviously, it is not a rule violation because these two strings are only for log file and they are not translatable messages.

But static analysis can only indicate there might be a rule violation because static analysis do not know if these strings are translatable messages.

Sample 4:

The usage of string concatenation is very common in most of the applications, so a lot of false warnings will be reported by static analysis. That costs a lot of time and effort to eliminate all these false warnings. Let's take a look at another piece of code:
String addressPart1=resourceBundle.getString(“msg.1”);
String addressPart2=resourceBundle.getString(“msg.2”);
String addressPart3=resourceBundle.getString(“msg.2”);
System.out.println(“My home address is: +addressPart1+addressPart2+addressPart3);

In this case, the three home addresses are translatable messages so we cannot use string concatenation in this case. It is a rule violation.

Then how can we identify this violation without manual inspection? We can use the validation matrix part 140. Here are the detail steps for the validation matrix part 140 to identify the violation:
1. The validation engine calls static analysis, static analysis indicates there may be a rule violation “Avoid using string concatenation for translatable messages”, but it is not sure.
2. The validation matrix part 140 determines to call dynamic analysis to see if there is multilingual data in three address parts.
3. The globalization rule implementation of dynamic analysis will be fired by validation engine and tells the validation engine the three messages contains multilingual data in this case.
4. Then the validation engine can report to end user and say there is a real globalization rule violation in this application.

Through this case, we can see the validation matrix part 140 can eliminate a lot of false warnings reported by the static analysis with the help of dynamic analysis. Neither static analysis nor dynamic analysis can perform this function alone._

While the preferred embodiment of the present invention has been described with respect to a hardware structure or method steps in the above, the operation method of the computer system according to the present invention can be implemented as computer program software. For example, the method according to an exemplary embodiment of the present invention can be embodied as a computer program product, which enables a computer to execute one or more exemplified methods. The computer program product may comprise a computer readable medium containing computer program logic or codes thereon for enabling the system to run according to one or more exemplified methods.

The computer readable storage medium can be a built-in medium in the computer body or a movable medium that can be arranged so that it can be detached from the computer body. The example of the built-in medium includes but is not limited to a rewritable non-volatile memory, such as an RAM, an ROM-+, a flash memory and a hard disk. The example of the movable medium can include but is not limited to an optical media such as CD-ROM and DVD; a magneto-optic storage media such as MO; a magnetic storage media such as a floppy disk (trademark), a cassette and a movable hard disk; and a media with a built-in ROM such as an ROM box.

The program of the method according to the present invention can also be provided in the form of externally provided broadcast signals and/or computer data signals included in a carrier wave. The computer data signals embodied as one or more instructions or functions of the exemplary method can be carried on the carrier wave sent and/or received by the entity for executing the instructions or functions of the exemplary method. Moreover, such a program can be stored and distributed easily when recorded on a computer readable storage media.

The above description is only illustrative substantially. Therefore the changes without departing from the essence of the present invention are intended to be within the scope of the present invention.

What is claimed is:

1. A computer system for validating application globalization issues by using globalization rules, comprising:
a globalization rules indicating part for implementing the globalization rules as XML definitions and probe definitions;
an application static analyzing part for searching for syntactic globalization issues in the application source code by using a static analysis technology with the help of the XML definitions of the globalization rules, implemented by the globalization rules indicating part;
an application running part for running an application whose globalization issues will be validated to generate a runtime environment of the application;
an application dynamic analyzing part for dynamically analyzing the application runtime environment by using a dynamic analysis technology with the help of the probe definitions of the globalization rules implemented by the globalization rules indicating part, so as to search for semantic globalization issues in the runtime environment; and
a validation matrix part for controlling the globalization rules indicating part, the application static analyzing part and the application dynamic analyzing part to validate the application globalization issues according to a execution sequence determined by the globalization rules.

2. The computer system for validating application globalization issues according to claim 1, wherein the validating matrix part also analyze rules coverage and generate an analysis report.

3. The computer system for validating application globalization issues according to claim 2, wherein the execution sequence includes static first, static only, dynamic first and dynamic only, wherein the static first indicates the application static analyzing part first performs static analysis on an application, then the application dynamic analyzing part performs dynamic analysis; the static only indicates that only the application static analyzing part performs static analysis on an application; the dynamic first indicates the application dynamic analyzing part first performs dynamic analysis on an application, and then the application static analyzing part performs static analysis; and the dynamic only indicates only the application dynamic analyzing part performs dynamic analysis on an application.

4. The computer system for validating application globalization issues according to claim 2, wherein the static analysis engine of the application static analyzing part is universal Rational Application Analyzer.

5. The computer system for validating application globalization issues according to claim 2, wherein the dynamic analysis engine of the application dynamic analyzing part is universal Rational ProbeKit.

6. The computer system for validating application globalization issues according to claim 2, wherein in the case that the execution sequence is static first or dynamic first, the validation matrix part controls the application static analyzing part and the application dynamic analyzing part to enable bidirectional interaction between static analysis and dynamic analysis results so as to identify real globalization defects and eliminate false warnings.

7. The computer system for validating application globalization issues according to claim 2, wherein a portion or all of the globalization rule indicating part, the application static analyzing part, the application dynamic analyzing part and the validation matrix part are included as plug-in in Rational Application Developer.

8. The computer system for validating application globalization issues according to claim 2, wherein the validation matrix part comprises:
a rules manager for storing the globalization rules that will be used for the validation, the execution sequence of the static analysis engine and dynamic analysis engine being determined by a globalization rule's definition, and the globalization rule's definition being made up of the execution sequence and required class, method and line number, recorded when a globalization expert inputs the globalization rules;
an analysis engine manager for controlling the execution of the static analysis engine of the application static analyzing part and the dynamic analysis engine of the application dynamic analyzing part according to the related information of the globalization rules set for analysis, inquired from the rules manager, providing inputs to the analysis engines and receiving outputs from the analysis engines, transforming interaction information of an analysis engine into interaction information of another analysis engine, wherein the interaction information is class name, method name, line number and rule ID; and
a testcase manager for storing all unit testcases for the application used for dynamic analysis as well as the mapping between application classes/methods and unit testcases so as to, when the analysis engine manager analyzes a specific class or method, find the right unit testcase for the class or method and execute the unit testcase to start dynamic analysis.

9. The computer system for validating application globalization issues according to claim 2, wherein the validation matrix part further includes a GUI for reception of user input, defects detection, fixing and generating a report for an end user.

10. A method for validating application globalization issues by using globalization rules in a computer system, said method comprising:
storing globalization issues for validation, and determining an execution sequence of static analysis engine and dynamic analysis engine through the definitions of the globalization rules, the definitions of the globalization rules being made up of by the execution sequence input by a globalization expert, class name, method name and line number, which are recorded;
instructing corresponding analysis engine to perform the analysis of the globalization issues prescribed by the execution sequence according to the determined execution sequence and related information about a globalization rules set for analysis;
according to the class name, method name, line number, content and status as the analysis result, directly finding some potential rule violations with this rule in the case of static analysis, and in the case of dynamic analysis, first running the application whose globalization issues are to be validated, then using a testcase corresponding to a special class to find some potential rule violations with this rule;
based on the analysis result and a determination result of whether another rule set of the globalization rules implementation should be used for dynamic analysis/static analysis, in the case that the other rule set of the globalization rules implementation is used for dynamic analysis/static analysis, receiving a globalization rule set for dynamic analysis/static analysis, and further receiving testcase if it is dynamic analysis case, so as to use the received globalization rule set for dynamic analysis/static analysis and/or the testcase to call corresponding dynamic analysis/static analysis engine; and
generating a report and presenting it to an end user according to the class name, method name, line number, content and status as the execution result of the analysis engine.

11. The method for validating application globalization issues according to claim 10, further comprising: in the case that the other rule set of the globalization rules implementation is used for dynamic analysis/static analysis, receiving testcase and using the received globalization rule set for dynamic analysis and the testcase to call corresponding dynamic analysis engine.

12. The method for validating application globalization issues according to claim 11, further comprising: before storing the globalization rules, analyzing rules coverage and generating an analysis report.

13. The method for validating application globalization issues according to claim 12, wherein the execution sequence includes static first, static only, dynamic first and dynamic only, wherein the static first indicates first performing static analysis on an application, then performing dynamic analysis; the static only indicates only performing static analysis on an application; the dynamic first indicates first performing dynamic analysis on an application, and then performing static analysis; and the dynamic only indicates only performing dynamic analysis on an application.

14. The method for validating application globalization issues according to claim 12, wherein the static analysis engine for performing static analysis is universal Rational Application Analyzer.

15. The method for validating application globalization issues according to claim 12, wherein the dynamic analysis engine for performing dynamic analysis is universal Rational ProbeKit.

16. The method for validating application globalization issues according to claim 12, further comprising: in the case that the execution sequence is static first or dynamic first, enabling bi-directional interaction between static analysis and dynamic analysis results so as to identify real globalization defects and eliminate false warnings.

17. A computer product having computer program codes encoded thereon in a computer executable format, which when executed by a computer, cause the computer to implement a method comprising:
storing globalization issues for validation, and determining an execution sequence of static analysis engine and dynamic analysis engine through the definitions of the globalization rules, the definitions of the globalization rules being made up of by the execution sequence input by a globalization expert, class name, method name and line number, which are recorded;
instructing corresponding analysis engine to perform the analysis of the globalization issues prescribed by the execution sequence according to the determined execution sequence and related information about a globalization rules set for analysis;
according to the class name, method name, line number, content and status as the analysis result, directly finding some potential rule violations with this rule in the case of static analysis, and in the case of dynamic analysis, first running the application whose globalization issues are to be validated, then using a testcase corresponding to a special class to find some potential rule violations with this rule;
based on the analysis result and a determination result of whether another rule set of the globalization rules implementation should be used for dynamic analysis/static analysis, in the case that the other rule set of the globalization rules implementation is used for dynamic analysis/static analysis, receiving a globalization rule set for dynamic analysis/static analysis, and further receiving testcase if it is dynamic analysis case, so as to use the received globalization rule set for dynamic analysis/static analysis and/or the testcase to call corresponding dynamic analysis/static analysis engine; and
generating a report and presenting it to an end user according to the class name, method name, line number, content and status as the execution result of the analysis engine.
